(19) United States
(12) Patent Application Publication
(10) Pub. No.: US 2025/0329818 A1
(43) Pub. Date: Oct. 23, 2025

(54) BATTERY MODULE AND METHOD OF MANUFACTURING THE SAME

(71) Applicant: SAMSUNG SDI CO., LTD., Yongin-si (KR)

(72) Inventor: Martin BLODER, Sinabelkirchen (AT)

(21) Appl. No.: 18/888,693

(22) Filed: Sep. 18, 2024

(30) Foreign Application Priority Data
Apr. 18, 2024 (EP) 24170927.8

(51) Int. Cl. H01M 10/6556; B21D 39/02; H01M 10/613; H01M 10/653; H01M 10/6554; H01M 50/209; H01M 50/224; H01M 50/231

(52) U.S. Cl. CPC H01M 10/6556; B21D 39/02; H01M 10/613; H01M 10/653; H01M 10/6554; H01M 50/209; H01M 50/224; H01M 50/231; H01M 2220/20

(57) ABSTRACT

A battery module includes a plurality of battery cells, and a frame including a bottom member and a plurality of side walls, the bottom member and the plurality of side walls forming an interior accommodation space configured to accommodate the plurality of battery cells, wherein at least two side walls opposite from each other among the plurality of side walls are bent and extend from the bottom member, wherein the at least two side walls and the bottom member are formed by a plate including a first metal sheet on an inner side of the plate and a second metal sheet on an outer side of the plate roll-bonded to each other, and wherein the plate further includes at least one cooling channel formed between bonding areas of the first metal sheet and the second metal sheet.

### CROSS-REFERENCE TO RELATED APPLICATION

The present application claims priority to and the benefit of European Patent Application No. 24170927.8, filed on Apr. 18, 2024, in the European Patent Office, the entire disclosure of which is incorporated herein by reference.

### BACKGROUND

### 1. Field

Aspects of the present disclosure relate to a battery module and a method of manufacturing the battery module. In addition, aspects of the present disclosure relate to a battery system or a battery pack including the battery module, and a vehicle including the battery system.

### 2. Description of the Related Art

Recently, vehicles for transportation of goods and peoples have been developed that use electric power as a source for motion. Such an electric vehicle is an automobile that is propelled permanently or temporarily by an electric motor, using energy stored in rechargeable batteries. An electric vehicle may be solely powered by batteries (as in the case of a battery electric vehicle (BEV)) or may include a combination of an electric motor and, for example, a conventional combustion engine (as in the case of a plugin hybrid electric vehicle (PHEV)). BEVs and PHEVs use high-capacity rechargeable batteries, which are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows movement of ions during charging and discharging of the battery cell. The electrode assembly is located in a casing and electrode terminals, which are positioned on the outside of the casing, and establish an electrically conductive connection to the electrodes. The shape of the casing may be, for example, cylindrical or rectangular.

A battery module is formed of a plurality of battery cells connected in series or in parallel. That is, the battery module is formed by interconnecting the electrode terminals of the plurality of battery cells depending on a required amount of power and in order to realize a high-power rechargeable battery.

Battery modules can be constructed in either a block design or in a modular design. In the block design each battery cell is coupled to a common current collector structure and a common battery management system and the unit thereof is arranged in a housing. In the modular design, pluralities of battery cells are connected together to form submodules and several submodules are connected together to form the battery module. In automotive applications, battery systems generally include a plurality of battery modules connected in series for providing a desired voltage.

A battery pack is a set of any number of (for example identical) battery modules or single battery cells. The battery modules and respective battery cells may be configured in series, in parallel or a mixture of both to deliver the desired voltage, capacity, and/or power density. Components of a battery pack include the individual battery modules and the interconnects, which provide electrical conductivity between the battery modules.

The mechanical integration of a battery pack requires appropriate mechanical connections between the individual components, for example, battery modules, and between them and a supporting structure of the vehicle. These connections must remain functional and save during the average service life of the battery system. Further, it is desirable for installation space and interchangeability requirements to be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors such as bolts or screws. Alternatively, the battery modules are confined by fastening side plates to lateral sides of the carrier framework. Further, cover plates may be fixed atop and below the battery modules.

The carrier framework of the battery pack is mounted to a carrying structure of the vehicle. In case the battery pack shall be fixed at the bottom of the vehicle, the mechanical connection may be established from the bottom side by for example bolts passing through the carrier framework of the battery pack. The framework is usually made of aluminum or an aluminum alloy to lower the total weight of the construction.

Battery systems according to the prior art, despite any modular structure, usually include a battery housing that serves as enclosure to seal the battery system against the environment and provides structural protection of the battery system's components. Housed battery systems are usually mounted as a whole into their application environment, for example, in an electric vehicle. Thus, the replacement of defect system parts, for example, a defective battery submodule, involves dismounting the whole battery system and removal of its housing first. Even defects of small and/or cheap system parts might then lead to dismounting and replacement of the complete battery system and its separate repair. As high-capacity battery systems are expensive, large, and heavy, said procedure proves burdensome and the storage, for example, in the mechanic's workshop, of the bulky battery systems becomes difficult.

An active or passive thermal management system may be included to provide thermal control of the battery pack, to safely use the at least one battery module by efficiently emitting, discharging, and/or dissipating heat generated from its rechargeable batteries. If the heat emission/discharge/dissipation is not sufficiently performed, temperature deviations may occur between battery cells, such that the at least one battery module may no longer generate a desired (or designed) amount of power. In addition, an increase of the internal temperature can lead to abnormal reactions occurring therein, and thus charging and discharging performance of the rechargeable battery deteriorates and the life-span of the rechargeable battery is shortened. Thus, cell cooling for effectively emitting/discharging/dissipating heat from the cells is desired.

Current battery modules accommodating a plurality of battery cells either consist of solid structures which need additional cooling plates or the battery modules are formed by extruded profiles both for the supporting frame as well as for the coolant channels.

Battery modules which incorporate additional cooling plates into the battery module involve an increased number of parts to be assembled together. This implies that the assembly effort is enhanced such that the manufacturing of the battery modules requires more manufacturing steps.

Battery modules which are produced through extruded profiles to build the frame and to incorporate the cooling channels therein involves complicated frame assembly operations. In addition, extruded profiles have inflexible design limitations with limited cooling performance to carry away excessive heat.

In both cases manufacturing effort is relatively high due to the number of assembly steps and parts so that a reduction of the number of manufacturing steps is desirable with respect to the mentioned battery modules. This also reduces manufacturing costs. In addition, more flexible cooling channel designs may be desired to improve the cooling performance of battery modules. Further, while simplifying the manufacturing process a substantial mechanical strength should be provided to enhance structural integrity when in use which may further allow an avoidance of additional framing.

The above information disclosed in this Background section is only for enhancement of understanding of the background of the invention and therefore it may contain information that does not form the prior art.

### SUMMARY

According to some aspects of the present disclosure, there is provided a battery module including: a plurality of battery cells, and a frame including a bottom member and a plurality of side walls, the bottom member and the plurality of side walls forming an interior accommodation space configured to accommodate the plurality of battery cells, wherein at least two side walls opposite from each other among the plurality of side walls are bent and extend from the bottom member, wherein the at least two side walls and the bottom member are formed by a plate including a first metal sheet on an inner side of the plate and a second metal sheet on an outer side of the plate roll-bonded to each other, and wherein the plate further includes at least one cooling channel formed between bonding areas of the first metal sheet and the second metal sheet.

In some embodiments, the first metal sheet includes at least one elongated protrusion obtained by inflation to form the at least one cooling channel, and the second metal sheet is flat.

In some embodiments, the at least one elongated protrusion includes a flat top surface and a curved side surface.

In some embodiments, bonding areas are formed at least on the bottom member and in bent edges where the at least two side walls are bent.

In some embodiments, the at least one cooling channel is formed in at least one of the bottom member and one or more of the two side walls.

In some embodiments, at least one cooling channel in the two side walls is connected by a connection channel member with at least one cooling channel in the bottom member.

In some embodiments, the plurality of side walls includes two end plates opposite to each other and fixed to at least one of the bottom member and the two side walls, at least one end plate of the two end plates are positioned indented with respect to an end of the bottom member, and the connection channel member is formed between the at least one end plate and the end of the bottom member.

In some embodiments, the plurality of side walls includes two end plates opposite to each other, the end plates being bent and extending from the bottom member or formed by deep drawing, and the connection channel member is formed inside the frame at a corner of the bottom member.

In some embodiments, the first metal sheet has a thickness less than a thickness of the second metal sheet.

In some embodiments, the first metal sheet and the second metal sheet include different material.

In some embodiments, the first metal sheet includes aluminum or an aluminum alloy and the second metal sheet includes a steel or a metal matrix composite.

In some embodiments, the first metal sheet has a thermal conductivity higher than a thermal conductivity of the second metal sheet.

According to some aspects of the present disclosure, there is provided a method of manufacturing a battery module, wherein the method includes: providing a plate by roll-bonding a first metal sheet with a second metal sheet; bending the plate so that at least two side walls opposite from each other are bent and extended from a bottom member; inflating of the plate such that at least one cooling channel is formed between bonding areas where the first metal sheet and the second metal sheet are roll-bonded; and providing a plurality of battery cells in an accommodation space formed at least by the bottom member and the at least two side walls.

In some embodiments, the inflating is performed before or after the bending of the plate.

According to some aspects of the present disclosure, there is provided a battery system including the battery module described above.

Further aspects of the present disclosure could be learned from the dependent claims or the following description.

### BRIEF DESCRIPTION OF THE DRAWINGS

Features will become apparent to those of ordinary skill in the art by describing in detail exemplary embodiments with reference to the attached drawings in which:

FIG. 1 illustrates a schematic perspective view of a battery module with battery cells therein according to some embodiments of the present disclosure;

FIG. 2 illustrates a schematic side view of the battery module according to some embodiments of the present disclosure;

FIG. 3 illustrates a schematic perspective view of the battery module without battery cells therein according to some embodiments some embodiments of the present disclosure;

FIG. 4 illustrates a schematic top view of a battery module without battery cells according to some embodiments of the present disclosure;

FIG. 5 illustrates a perspective view of a battery module without battery cells according to some other embodiments of the present disclosure;

FIG. 6 illustrates a schematic top view of the battery module without battery cells according to some other embodiments of the present disclosure; and

FIG. 7 schematically illustrates a method of manufacturing according to some embodiments of the present disclosure.

### DETAILED DESCRIPTION

Reference will now be made in detail to some embodiments, examples of which are illustrated in the accompanying drawings. Effects and features of the exemplary embodiments, and implementation methods thereof will be described with reference to the accompanying drawings. In the drawings, like reference numerals denote like elements, and redundant descriptions are omitted. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/−5% of the value centered on the value. Furthermore, a specific quantity or range recited in this written description or the claims may also encompass the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

When one or more embodiments may be implemented differently, a specific process order may be performed differently from the described order. For example, (i) the disclosed operations of a process are merely examples, and may involve various additional operations not explicitly covered, and (ii) the temporal order of the operations may be varied.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification.

According to some aspects of the present disclosure, a battery module is provided. The battery module includes a plurality of battery cells. A frame is provided which includes a bottom member or bottom portion and a plurality of side walls. The bottom member and the plurality of side walls form an internal accommodation space in which the plurality of battery cells is accommodated and/or supported. At least two side walls opposite from each other among the plurality of side walls are bent and extended from the bottom member or bottom portion. The at least two side walls and the bottom member are formed by a plate comprising a first metal sheet on an inner side of the plate and a second metal sheet on an outer side of the plate. Here, the first metal sheet and the second metal sheet are roll-bonded to each other. The plate further includes at least one cooling channel formed by inflation between bonding areas where the first metal sheet and the second metal sheet are roll-bonded or, in other words, form roll-bonded connections.

The at least two side walls being bent and extended from the bottom member may form a U-shape. That is, the bottom portion may include bend corners from which the at least two side walls extend. The battery cells may form a stack of battery cells. The at least two side walls may extend in perpendicular direction from said bottom portion. The roll bonding refers to particular form of connecting metal sheets with each other. In practice, two metal sheets may be passed through a pair of flat rollers exposed to sufficient pressure to bond the layers. The pressure is set high enough to deform the metals and reduce the combined thickness. Heating in form of preheating may be added depending on the selected bonding conditions. The mating surfaces may be prepared before the bonding process. The formation of the cooling channels by inflating may be provided by coating (e.g., with release agent or separation agent) a cooling channel layout on one among the metal sheets according to the desired cooling channels to be formed. Then, only the bare or uncoated metal surfaces bond in the roll bonding process. These areas refer to the bonding areas. Then, the un-bonded parts corresponding to the cooling channel layout are inflated. An inflation may be generated through heating the metal sheets or at least one of the metal sheets, or by applying fluid pressure at the inlet and outlet ports. For the inflating, for example, a pressure generating device like a pump, a compressor or other sources that can cause high fluid pressure may be connected to an end (e.g., a port) of the to-be inflated cooling channel (i.e., the unbonded areas) so that a fluid pressure (e.g., for air or coolant) causes inflation to form the at least one cooling channel. A limitation of the inflation can be achieved by the battery cells in a state where the battery cells are installed so that the inflation of the respective channel adapts and thus compensates the tolerances of the battery cells. In some examples, to reach a determined shape for the at least one cooling channel, a contour defining member may be provided which limits extension for the inflation and provides a defined shape. In order to connect the to-be-inflated cooling channel to the pressurized medium, a welded, soldered or otherwise very well-connected connection to the respective channel may be desirable (e.g., may be an advantage). To improve the connections, a hose sleeve or a pipe may be directly welded to the channel that is to be inflated. The un-bonded areas may be formed between the bonded areas. The inflation operation to generate the cooling channels may be performed after or before the bending process. The metals of the first metal sheet and the second metal sheet may be the same material in some embodiments. The roll-bonding allows the integration of the cooling channels. The cooling channels may be connected to cooling ports and coolant media may flow through the cooling channel. Here, the inner side may refer to the side directed to (e.g., facing) the accommodation space or to the battery cells, and the outer side may refer to the side directed away from the accommodation space or the battery cells.

The battery module has a desirable feature in that it can be easily manufactured while including the cooling channels directly inside the frame corpus without an additional assembly step. Thus, compared to the processes of extruded profiles and methods with separate cooling channels significant manufacturing costs can be reduced. Thus, through folding of the roll bonded sheet metal prior or after the inflation, a frame is produced that already resembles most commonly used cell module frames. Thus, by merely providing the bending of the roll bonded sheet metal, at least a u-shaped frame is provided to mechanically support and accommodate the battery cells. In addition, desired channel structures can be generated with high cooling performance in the frame. Further, due to the integration of the cooling channels directly in the frame, excessive heat generated by the battery cells may be efficiently carried away to prevent or substantially reduce an overheated state in the battery module or at a battery cell in the battery module.

According to some embodiments, the first metal sheet formed on the inner side includes at least one elongated protrusion to form the at least one cooling channel. The second metal sheet formed on the outer side of the plate is flat. In such embodiments, the cooling channels are close to the interior where the battery cells are disposed so that good heat transfer (e.g., high heat transfer) is achieved. On the other hand, the outer surface remains entirely flat and thus can be stably supported in a carrier framework or any other support surface.

According to some embodiments, the at least one elongated protrusion, or the corresponding coolant channel, includes a flat top surface and curved side surfaces. Thus, due to the flat top surface, despite the cooling channels being formed on the inner side, the battery cells can be directly positioned on the plate. In particular, the flat top surfaces together may act as a support area for another functional layer or for the battery cells, that is, the battery cell stack. The flat top surface may be achieved by using a flat inflation barrier plate in the inflation process to prevent or substantially reduce inflation beyond the flat inflation barrier plate so to provide a flat top surface with equal height. The flat inflation barrier plate can be removed after the inflation process.

According to some embodiments, the bonding areas are formed at least on the bottom member and in bent edges of the plate where the at least two side walls are bent. Thus, despite the formation of the several coolant channels, the bonding strength in the plate is enhanced to withstand delamination forces that may act in the bent edges due to the bending. Thus, the roll-bonded plate or frame is strengthened by providing roll-bonding connections directly in the bent edges or corner areas.

According to some embodiments, the at least one cooling channel is formed in the bottom member. Thus, an effective cooling of the battery cells can be provided and excessive heat can be transported away through the use of a coolant transported in the cooling channel. In some examples, the coolant channels may include a plurality of parallel extending straight portions connected to each other by curved end portions. The curved end portions may be formed at ends of the bottom portion. The curved portions may provide a reverse turn. That is, the turns may be 180°-turns. The cooling channels may form meanders (e.g., windings) to cover the support area of the battery cells and to increase the cooling performance.

According to some embodiments, the at least one cooling channel is formed in at least one of the two opposite side walls. In some embodiments, the at least one cooling channel may be formed in at least one of the two opposite side walls and the bottom member. Thus, because the cooling channel can be easily formed by the roll bonding in the side walls, the cooling effect can be enhanced in this manner because excessive heat formed at the top or side of the battery cells can be carried away. Similar to the bottom member, the coolant channels in the side walls may include a plurality of parallel extending straight portions connected to each other by curved coolant portions. The curved portions may be formed at ends of the side walls. The curved portions may provide a full reverse turn. That is, the turns may be 180° turns. The cooling channels may form meanders (e.g., windings).

According to some embodiments, at least one coolant channel formed in the two opposite sidewalls is connected by a connection channel member with the at least one cooling channel in the bottom member. Thus, a single cooling channel path through side walls and bottom portion may be provided in the frame. Therefore, cooling performance for the plurality of battery cells accommodated therein can be enhanced while not increasing the number of additionally required cooling ports.

According to some embodiments, the plurality of side walls includes two end plates opposite to each other and fixed to the bottom member and/or the two opposite side walls. For example, fixing may be achieved by welding, that is, providing a weld connection, or by riveting or bolting. Thus, conventional end plates can be combined with the roll bonded plate to complete the frame beside the side walls and the bottom portion formed by the roll bonded metal sheets.

According to some embodiments, the end plates are fixed by a snap-fit connection. A snap-fit connection easily allows exertion of a force (e.g., pressure force) on the battery cells or battery cell stack. This may also efficiently prevent or substantially reduce swelling of the plurality of battery cells in the battery module.

According to some embodiments, at least one of the two end plates are axially displaced with respect to an end of the bottom member. In other words, the at least one end plate may be indented with respect to the end of the bottom member. The connection channel member may be formed between the at least one indented end plates and the end of the bottom member. Thus, a continuous coolant channel path can be provided by making use of the fact that the end plates are separate from the plate and thus can be axially displaced.

According to some embodiments, the plurality of side walls includes two end plates opposite to each other. Here, the end plates are bent and extended from the bottom member. Thus, the end plates are also integrated into the frame that reduces the number of assembly steps. The end plates thus form side walls together with the other side walls. Thus, an integral frame including all side walls and bottom portion is provided. This reduces further additional fixation effort and thus further reduces the manufacturing effort and the need for additional fixation means.

According to some embodiments, the plurality of side walls includes two end plates opposite to each other. The end plates are formed by deep drawing from the bottom member. Therefore, the end plates are also integrated into the frame. Thus, an integral frame including all side walls and bottom portion is provided. This reduces further fixation and thus further reduces the manufacturing effort and the need for additional fixation means.

According to some embodiments, the connection member is formed inside the frame at a corner of the bottom member. Therefore, the frame is not impacted by the addition of the connection member. Further, loss of support space is reduced by using the corners for the connection. Thus, a continuous cooling path through the frame can be provided.

According to some embodiments, the first metal sheet has a first thickness less than a second thickness of the second metal sheet. For example, but not restricted thereto, the first thickness may be about 0.5 mm to about 2 mm. For example, but not restricted thereto, the second thickness may be about 3 mm to about 5 mm. Thus, the second metal sheet may provide structural integrity to the frame by thickness while the first thinner metal sheet may be suitable for the cooling channel generation by inflation due to the reduced thickness. Thus, it may be possible to incorporate structural mechanical requirements together with providing cooling performance.

According to some embodiments, the first metal sheet and the second metal sheet include different metals and/or different metal alloys. Thus, the inner side of the frame and the outer side of the frame can be separately designed according to a desired functionality. For example, it may be desirable for the inner side to have higher heat conductivity as it is closer to the heat generating battery cells, while it may be desirable for the outer side of the frame to have more structural robustness to prevent or substantially reduce deformation. Thus, the roll bonding can be used to tailor the frame for the specific technical needs. For example, resistance against crash/abuse load cases, swelling forces or vibration resistance is increased. In addition, general stiffness is increased.

According to some embodiments, the first metal sheet includes aluminum or an aluminum alloy and the second metal sheet includes a steel or a metal matrix composite. Thus, resistance against crash/abuse load cases, swelling forces or vibration resistance is increased. In addition, general stiffness is increased due to the steel or the metal matrix composite. Steel can be produced on large scale and is thus better for large scale production of battery modules. The metal matrix composite may include fibers or particles dispersed in the metallic matrix. Thus, the plate can be reinforced to increase the structural integrity and swelling absorbance.

According to some embodiments, the first metal sheet has a thermal conductivity higher than the thermal conductivity of the second metal sheet. Therefore, the inner first metal sheet may act as a heat conductor that rapidly transports heat away, thus acting as a cooling channel. Thus, cooling performance can be furthermore increased.

According to some embodiments, additive particles are used in the roll-bonding. Thus, bonding may be strengthened to reinforce the frame while reducing the risk of delamination. For example, metallic particles or ceramic particles may be added during the roll bonding.

According to some other embodiments, a method of manufacturing a battery module includes: a) providing a plate by roll-bonding a first metal sheet with a second metal sheet and b) bending the plate so that at least two side walls opposite from each other are bent and extended from a bottom member. The method further includes inflating c) of the plate such that at least one cooling channel is formed between the first metal sheet and the second metal sheet. The method further includes d) providing or inserting a plurality of battery cells in an accommodation space formed at least by the bottom member and the at least two side walls.

The method has a desirable feature in that the battery module can be easily manufactured while including the cooling channels directly in the frame itself. Thus, compared to the processes of extruded profiles and methods with separate cooling channels significant manufacturing costs can be reduced. In particular, through folding of the roll bonded sheet metal prior or after their inflation, a frame can be made that already resembles most commonly used cell module frames. Thus, only by the bending of the roll bonded sheet metal, u-shaped frame is readily provided. In addition, due to the integration of the cooling channels directly in the frame, heat can be efficiently carried away.

The additional features as mentioned in the context of describing embodiments with respect to the battery module can be combined with the above-described method resulting in the same desirable effects as described above.

According to other aspects of the disclosure, there is provided a battery system or a battery pack comprising the battery module according to the above embodiments.

According to other aspects of the disclosure, there is provided a vehicle comprising the battery module or the battery system according to the above embodiments.

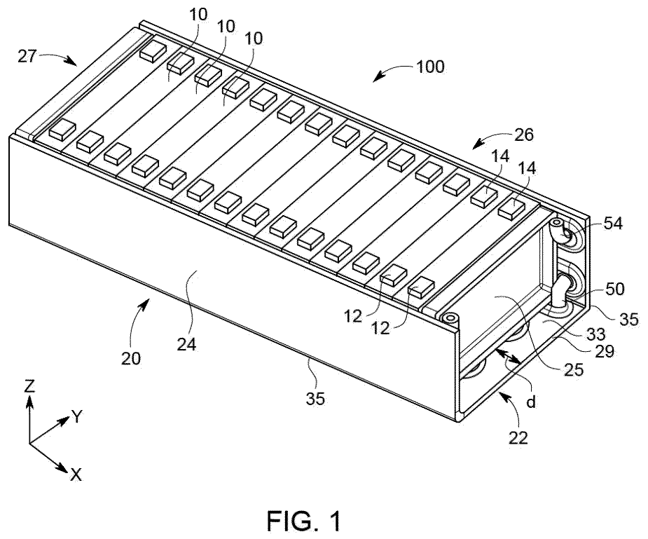

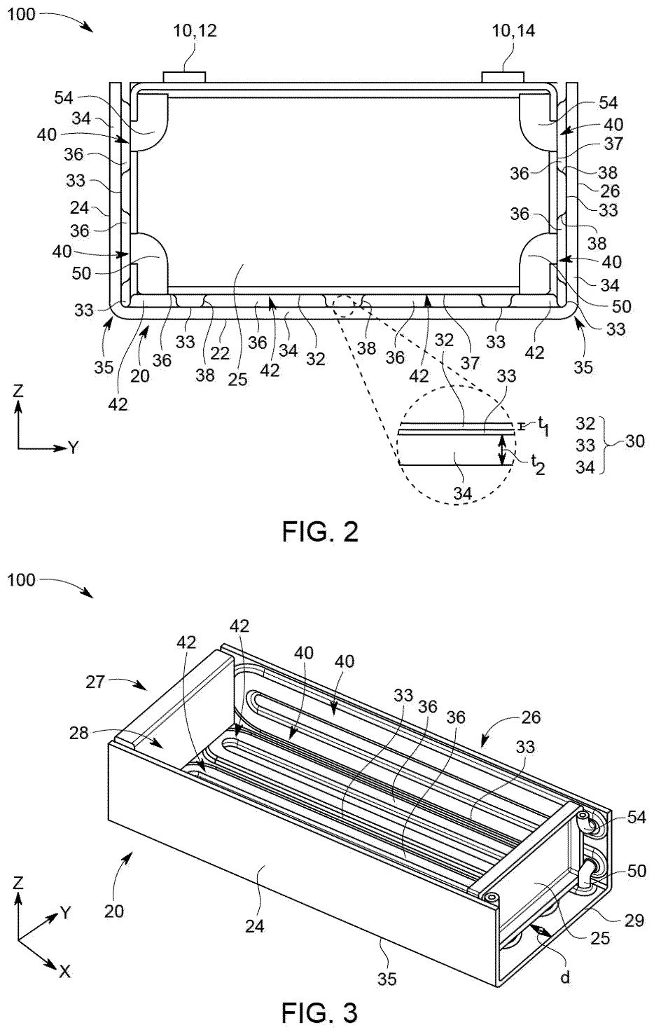

FIGS. 1 to 4 show a battery module 100 according to various embodiments of the present disclosure from different perspectives. FIG. 1 shows a schematic perspective view of a battery module 100 including a plurality of battery cells 10. FIG. 2 shows a side view of the battery module 100 in x-direction (in particular in (−x)-direction). In particular, FIG. 2 shows the battery module 100 in a side view when viewed in a direction facing the end plates. FIG. 3 shows a schematic perspective view of a battery module 100 according to some embodiments without battery cells 10. FIG. illustrates a schematic top view of a battery module 100 according to some embodiments without battery cells 10. In the following, the battery module 100 will be described with reference to FIGS. 1 to 4.

Referring to FIGS. 1 and 2, the battery module 100 includes a plurality of battery cells 10. The battery cells 10 may each include a first terminal 12 and a second terminal 14 with opposite polarity. Further, the battery cells 10 may be interconnected according to a desired voltage output. The plurality of battery cells 10 form a battery cell stack. The battery cells 10 may be prismatic battery cells 10 as shown in FIG. 1. However, different formats of battery cells 10 may also be stacked together or positioned with respect to each other in a suitable manner.

The battery module 100 further includes a frame 20. The frame 20 surrounds and supports the plurality of battery cells 10 of the battery module 100. The frame 20 includes a bottom member 22 and a plurality of side walls 24, 25, 26, and 27 as indicated in the respective FIGS. 1 to 4. The bottom member 22 and the plurality of side walls 24, 25, 26, and 27 form an interior accommodation space 28 in which the plurality of battery cells 10 is accommodated or inserted. The accommodation space is shown in FIG. 3 where the battery cells 10 are not included for ease of illustration purposes.

Two side walls 24 and 26 opposite from each other among the plurality of side walls 24, 25, 26, and 27 are bent and extended from the bottom member 22. The respective side walls 24 and 26 may extend in perpendicular direction, here a z-direction, from the bottom member 22. Thus, bent edges 35 are generated due to the bending as indicated in FIG. 1. The at least two side walls 24 and 26 together with the bottom member 22 form a u-shaped or flat u-shaped cross section when viewed in x-direction as illustrated in FIGS. 1 and 2.

The two side walls 24 and 26 and the bottom member 22 are formed by a plate 30. The plate 30 is illustrated in detail in FIG. 2, and in the enlarged inset of FIG. 2. The plate 30 includes a first metal sheet 32 on an inner side of the plate 30 and a second metal sheet 34 on an outer side of the plate 30. The inner side and the outer side are defined with respect the accommodation space 28 or, equivalently, with respect to the plurality of battery cells 10 accommodated therein.

The first metal sheet 32 and the second metal sheet 34 are roll-bonded to each other. This is illustrated in the enlarged inset in FIG. 2. The first metal sheet 32 and the second metal sheet 32 thus include bonding areas 33 where the first metal sheet 32 and the second metal sheet 34 are roll-bonded to each other.

The plate 30 further includes at least one cooling channel 40/42. The cooling channels 40 and 42 are formed by inflation, for example, by applying high pressure to the unbonded regions, between the bonding areas 33 where the first metal sheet 32 and the second metal sheet 34 are roll bonded. In the roll-bonding, a separation agent or coating can be used in the roll-bonding to prevent or substantially reduce a bonding at the locations where the cooling channels 40 and 42 are to be formed. The controlled coating produces a cooling channel layout that is then inflated to generate the cooling channels 40 and 42. Thus, the cooling channels 40 and 42 are fully integrated within the entire corpus (e.g., body) of the frame 20 without the requirement of an additional assembly step or additional fixation means, which eases the manufacturing and allows for the desired channel structures to be generated with high cooling performance.

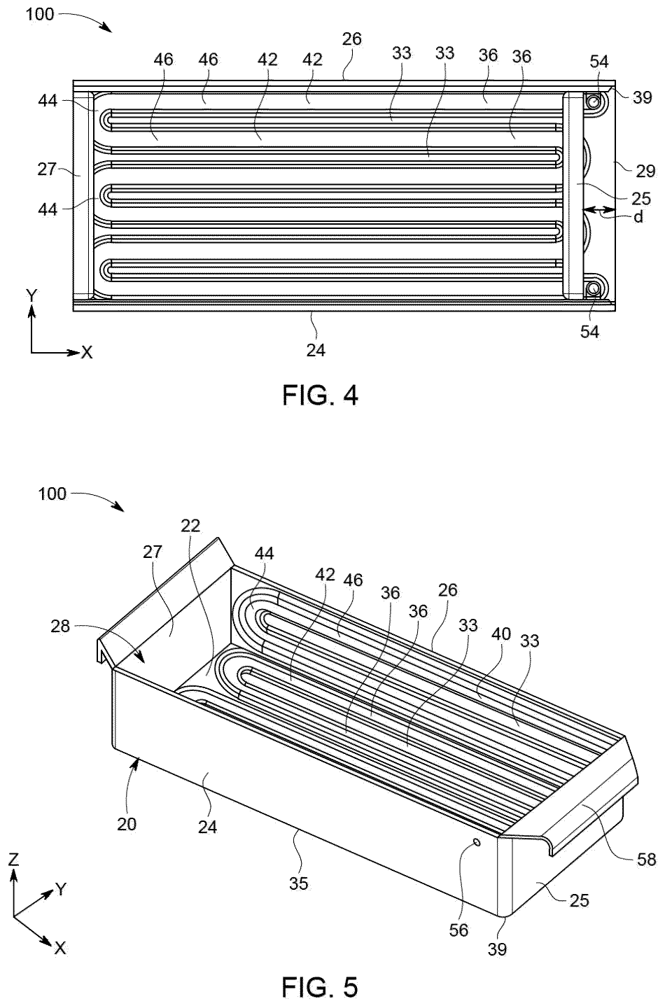

The cooling channels 40 and 42 may be connected to each other to form a continuous channel provided within the frame 20. For example, a plurality of curved channel end portions 44 may connect a plurality of straight cooling channel portions 46 to form the continuously connected cooling channels 40 and 42. An example is shown in FIGS. 3 and 4 or in the side view according to FIG. 1. This can reduce an amount of cooling ports required.

As shown in the side view of FIG. 2, the first metal sheet 32 is profiled on the inner side. The first metal sheet 32 includes at least one elongated protrusion 36 on the inner side. The elongated protrusion 36 are generated by the inflation to form the at least one cooling channel 40 and 42. Further, the second metal sheet 34 may be flat as indicated in FIG. 2. Thus, an outer side of the frame 20 remains unstructured. Therefore, the battery module 100 can be easily supported by a carrier framework while providing efficient cooling to the battery cells 10 through the cooling channels 40 and 42 formed to protrude in the inner direction. In some other examples, the cooling channels 40 and 42 and/or the protrusions 36 may be formed on the outer side of the frame 20.

The at least one elongated protrusions 36, as illustrated in FIG. 2, include a flat top surface 37 and curved side surfaces 38. That is, flat top surfaces 37 are provided despite the profiled inner side due to the protrusions 36. Thus, despite of having the profiled inner side, the battery cells 10 can be directly supported by the flat top surfaces 37 of the profiled inner side. This can reduce a heating distance.

Referring to FIG. 1, the bonding areas 33 are formed at least on the bottom member 22 to form bonding areas 33 between the first metal sheet 32 and the second metal sheet 34. Between these bonding areas 33, the cooling channels 40 and 42 are formed. Thus, the at least one cooling channels 40 and 42 are formed in unbonded areas. Because the plate 30 is bent, they form at least a u-shape profile. Due to the bending and due to the at least one cooling channel 40 and 42 forces like delamination may act on the first metal sheet 32 and the second metal sheet 34 in the bent edge 35. Therefore, bonding areas 33 are provided in the bent edge 35 where the at least two side walls 24 and 26 are bent. This is illustrated in FIG. 1. Thus, due to the use of the bonding areas 33 delamination in the bent edges 35 due to delamination forces may be prevented or substantially reduced and the bent edge 35 may be mechanically stabilized.

In addition, the at least one cooling channel 40 and 42 is formed in the bottom member 22 and in at least one of the two opposite side walls 24 and 26. This is demonstrated in FIG. 3 as well as in the side view of FIG. 1. This can be easily produced by the roll bonding by inflating the plate 30 before or after bending and allows for better cooling performance to also carry heat away from upper parts of the battery cells 10.

The first metal sheet 32 may have a first thickness t1 less than a second thickness t2 of the second metal sheet 34. For example, the first thickness t1 may be about 0.5 mm to about 1.5 mm, and the second thickness t2 may be about 2 mm to about 4 mm. Thus, the second metal sheet 34 may provide structural integrity to the frame 20 while the first metal sheet 32 remains thin to be easily inflatable to produce the cooling channels 40 and 42. Thus, by increasing the second thickness t2 of the second metal sheet 34 relative to the first thickness t1 of the first metal sheet 32 it is possible to incorporate structural mechanical requirements of the frame 20. Thus, the second metal sheet 34 can be used to provide mechanical strength while the first metal sheet 32 remains relatively thin to provide the cooling channels 40 and 42 by inflation. Therefore, mechanical strength to withstand crash/abuse load cases, swelling forces and of course general stiffness and vibration resistance for vehicle operation can be enhanced. Therefore, any additional framing of the battery cells 10 may not be needed

In addition, the first metal sheet 32 and the second metal sheet 34 may include different metals and/or different metal alloys. This allows making use of the roll-bonding procedure to specifically designate mechanical or heat conduction properties to the inner or outer metal sheet. For example, the first metal sheet 32 may include an aluminum or an aluminum alloy while the second metal sheet 34 may include a steel or a metal matrix composite. Thus, the relatively good heat conduction of aluminum or an aluminum alloy is used for the inner first metal sheet 32. The mechanical robust steel is provided as second metal sheet 34 to enhance the mechanical strength of the entire plate 30 and the entire frame 20. In some other embodiments, the second metal sheet may be metal matrix composite to structurally reinforce the second metal sheet 34 and the frame 20.

The different metal materials can also be selected according to heat conduction criteria. For example, the first metal sheet 32 may have a thermal conductivity higher than the thermal conductivity of the second metal sheet 34. Because excessive heat should be rapidly carried away from the battery cells 10, the first metal sheet 32 having a higher thermal conductivity than the thermal conductivity of the second metal sheet 34 may facilitate releasing of heat away from the battery cells 10. Additional embodiments are directed to enhance the coupling strength of the roll-bonding connection between the first metal sheet 32 and the second metal sheet 34, for example, by additive particles used in the step of roll-bonding.

Thus, the battery modules 100 can be tailored by the above features to provide good heat conduction, mechanical stability and structural reinforcement to withstand crash/abuse load cases, swelling forces and of course general stiffness and vibration resistance for vehicle operation making use of the roll bonding connection.

As for example shown in FIGS. 1 to 3, the at least one cooling channel 40 in the two opposite side walls 24 and 26 is connected by a connection channel member with at least one cooling channel 42 in the bottom member 22. The connection channel member 50 in some embodiments may have the form of a knee or a bended portion that connects cooling channels between the respective side wall 24 and 26 and the bottom member 22 as shown for example in FIGS. 1 and 2.

The plurality of side walls 24, 25, 26, and 27 in the embodiments of FIGS. 1 to 4 include two end plates 25 and 27 opposite to each other. The end plates 25 and are fixed to the bottom member 22 and/or the two opposite side walls 24 and 26. For example, the fixing may be performed by fixation techniques like welding, snap-fitting, bolting, riveting, and/or the like.

In some embodiments, one of the two end plates, here end plate 25, are positioned axially displaced inwards with respect to an end 29 of the bottom member 22. That means, as shown in FIG. 1, the end 29 of the bottom member 22 is distanced from the inwardly displaced end plate 25 by a displacement distance d as shown in FIG. 1. The end plate 25 may be directly disposed on the flat top surfaces 37 of the at least one cooling channels 40 and 42.

Further, the connection channel member 50 is formed between the inwardly displaced end plate 25 and the end 29 of the bottom member 22. Thus, the cooling channels 40 and 42 of different sides can be continuously connected within the frame 20, and by making use of that, the end plate 25 is separate from the plate 30 so that it can be axially displaced inwards.

Further, cooling ports 54 can be provided in the battery module 100 to allow the supply or the draining of coolant to and from the connected cooling channels 40 and 42. For example, the cooling ports 54 may be overlapping or positioned above the connection channel member 50 in a corner 39 of the bottom member 22.

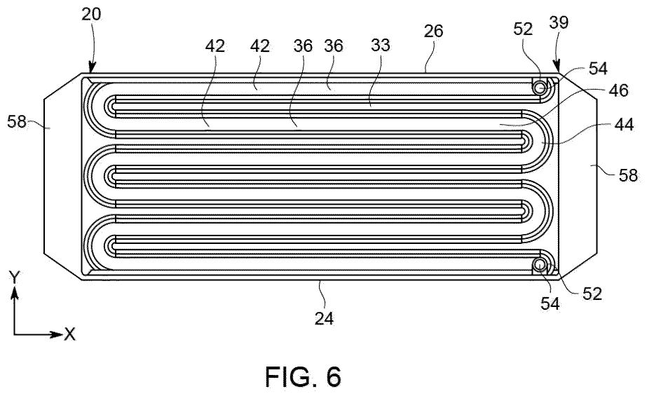

FIG. 5 and FIG. 6 show a battery module 100 according to some other embodiments of the present invention. FIG. 5 illustrates a perspective view of the battery module 100 according to come other embodiments without battery cells. FIG. 6 illustrates a schematic top view of the battery module 100 according to some embodiments. In the present case, only the differences with respect to the embodiments according to the FIGS. 1-4 are described for conciseness. The variously described features above apply to the embodiments pf FIGS. 5 and 6 as well and are incorporated herein by reference.

The plurality of side walls 24, 25, 26, and 27 include two end plates 25 and 27 opposite to each other. In some embodiments, the end plates 25 and 27 are bent and extended from the bottom member 22 or are formed by deep drawing. Thus, an additional fixation and manufacturing step can be avoided because an integral frame 20 is generated. This reduces the amount of assembly steps and assembly parts because additional fixation is not required.

Further, as indicated in an example in FIG. 6, a connection channel member is formed inside the frame 20 at a corner 39 of the bottom member 22. In some embodiments, the size of the accommodation space 28 may be remain comparably large because only a small amount of support space is lost. The remaining features that are described with respect to FIGS. 1 to 4 are included herein by reference.

In addition, in some embodiments, an interconnection cooling port 56 is provided on at least one among the side walls 24 and 26. This interconnection cooling port 56 may be provided as well in the embodiments of FIG. 1. This interconnection cooling port 56 may allow to interconnect the cooling channels 40 and 42 of different battery modules 100. In addition, flaps 58 may be provided at the upper portion of the end plates 25 and 27.

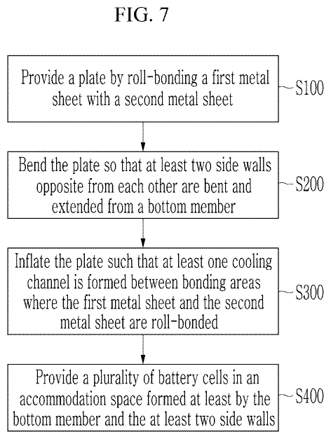

In FIG. 7 a schematic method of manufacturing a battery module 100 is provided. The method includes providing (S100) a plate 30 by roll-bonding a first metal sheet 32 with a second metal sheet 34. In some examples, two metal sheets are passed through a pair of flat rollers exposed to sufficient pressure to bond the sheets. The pressure is high enough to deform the metals and reduce the combined thickness. Heating in the form of preheating may be added depending on the selected bonding conditions.

The method further includes bending (S200) the plate 30 so that at least two side walls 24 and 26 opposite from each other are bent and extended from a bottom member 22 of the plate 30. Thus, a u-shaped profile may be provided by the bending.

The method may further include inflating (S300) of the plate 30 such that at least one cooling channel 40 and 42 is formed between bonding areas 33 where the first metal sheet 32 and the second metal sheet 34 are roll-bonded. In an example, the formation of the cooling channels 40 and 42 by inflating may be provided by coating (e.g., with release agent or separation agent) a cooling channel layout on one among the metal sheets according to the desired cooling cannel design. Then, only the uncoated metal surfaces bond in the roll bonding process. These areas refer to the bonding areas 33. The inflation may be generated by applying pressure to the unbonded areas. For the inflating, for example, a pressure generating device like a pump, a compressor or other sources that can cause high fluid pressure may be connected to an end (e.g., a port) of the to-be inflated cooling channel (i.e., the unbonded areas) so that a fluid pressure causes inflation to form the at least one cooling channel 40 and 42. A limitation of the inflation can be achieved by the battery cells in a state where the battery cells 10 are installed so that the inflation of the respective channel adapts and thus compensates the tolerances of the battery cells 10. In some examples, to reach a determined shape for the at least one cooling channel, a contour defining member may be provided which limits extension for the inflation and provides a defined shape. In order to connect the to-be-inflated cooling channel to the pressurized medium, a welded, soldered or otherwise very well-connected connection to the respective channel may be an advantage. To improve the connections, a hose sleeve or a pipe may be directly welded to the channel that is to be inflated. Thus, the roll-bonding easily allows the integration the cooling channels in a frame. The inflating S300 may be performed before or after the bending (S200) the plate 30.

In addition, the present disclosure includes providing (S400) a plurality of battery cells 10 in an accommodation space 28 formed at least by the bottom member and the at least two side walls 24 and 26. Further, a top cover may be provided to close the battery module 100 in some embodiments or may remain open in some other embodiments.

In summary, a battery module 100 and a manufacturing method is provided that allows easy and fast manufacturing while including cooling channels 40 and 42 directly in the frame 20 itself. Thus, only by bending of the roll bonded plate 30, at least a u-shaped frame 20 is directly obtained without additional fixation means. In addition, due to the integration of the cooling channels directly in the frame, heat can be efficiently carried away. Several measures can be incorporated that enhance structural integrity, heat conduction and structural reinforcement and/or colling channel interconnectivity as described above making use of the roll bonding connection.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

### SOME OF THE REFERENCE NUMERALS

100 battery module
10 battery cell
12 first terminal
14 second terminal
20 frame
22 bottom member
24, 26 side wall
25, 27 end plate (side wall)
28 accommodation space
29 end
30 plate
32 first metal sheet
33 bonding area
34 second metal sheet
35 bent edge
36 protrusion
37 top surface
38 curved side surface
39 corner
40 cooling channel
42 cooling channel
44 curved cooling channel end portion
46 straight cooling channel portion
50 connection channel member
52 connection channel member
54 cooling port
56 interconnection cooling port
58 flap
S100 providing the plate
S200 bending the plate
S300 inflating the plate
S400 providing battery cells
d indentation distance
t1 first thickness
t2 second thickness

What is claimed is:

1. A battery module comprising:
a plurality of battery cells; and
a frame comprising a bottom member and a plurality of side walls, the bottom member and the plurality of side walls forming an interior accommodation space configured to accommodate the plurality of battery cells,
wherein at least two side walls opposite from each other among the plurality of side walls are bent and extend from the bottom member,
wherein the at least two side walls and the bottom member are formed by a plate comprising a first metal sheet on an inner side of the plate and a second metal sheet on an outer side of the plate roll-bonded to each other, and
wherein the plate further comprises at least one cooling channel formed between bonding areas of the first metal sheet and the second metal sheet.

2. The battery module as claimed in claim 1, wherein:
the first metal sheet comprises at least one elongated protrusion obtained by inflation to form the at least one cooling channel, and
the second metal sheet is flat.

3. The battery module as claimed in claim 2, wherein the at least one elongated protrusion comprises a flat top surface and a curved side surface.

4. The battery module as claimed in claim 1, wherein bonding areas are formed at least on the bottom member and in bent edges where the at least two side walls are bent.

5. The battery module as claimed in claim 1, wherein the at least one cooling channel is formed in at least one of the bottom member and one or more of the two side walls.

6. The battery module as claimed in claim 5, wherein at least one cooling channel in the two side walls is connected by a connection channel member with at least one cooling channel in the bottom member.

7. The battery module as claimed in claim 6, wherein:
the plurality of side walls comprises two end plates opposite to each other and fixed to at least one of the bottom member and the two side walls,
at least one end plate of the two end plates are positioned indented with respect to an end of the bottom member, and
the connection channel member is formed between the at least one end plate and the end of the bottom member.

8. The battery module as claimed in claim 6, wherein:
the plurality of side walls comprises two end plates opposite to each other, the end plates being bent and extending from the bottom member or formed by deep drawing, and
the connection channel member is formed inside the frame at a corner of the bottom member.

9. The battery module as claimed in claim 1, wherein the first metal sheet has a thickness less than a thickness of the second metal sheet.

10. The battery module as claimed in claim 1, wherein the first metal sheet and the second metal sheet comprise different material.

11. The battery module as claimed in claim 10, wherein the first metal sheet comprises aluminum or an aluminum alloy and the second metal sheet comprises a steel or a metal matrix composite.

12. The battery module as claimed in claim 10 wherein the first metal sheet has a thermal conductivity higher than a thermal conductivity of the second metal sheet.

13. A method of manufacturing a battery module, the method comprising:
providing a plate by roll-bonding a first metal sheet with a second metal sheet;
bending the plate so that at least two side walls opposite from each other are bent and extended from a bottom member;
inflating the plate such that at least one cooling channel is formed between bonding areas where the first metal sheet and the second metal sheet are roll-bonded; and
providing a plurality of battery cells in an accommodation space formed at least by the bottom member and the at least two side walls.

14. The method as claimed in claim 13, wherein the inflating is performed before or after the bending of the plate.

15. A battery system comprising the battery module as claimed in claim 1.
